(19) United States
(12) Patent Application Publication
(10) Pub. No.: US 2013/0025695 A1
(43) Pub. Date: Jan. 31, 2013

(54) TOILET WATER SUPPLY SYSTEM AND METHOD THEREFOR

(71) Applicants: Dalia KATZIR, Reut (IL); Sasi KATZIR, Reut (IL)

(72) Inventors: Dalia KATZIR, Reut (IL); Sasi KATZIR, Reut (IL)

(21) Appl. No.: 13/194,951

(22) Filed: Jul. 31, 2011

(51) Int. Cl. F16K 21/18

(52) U.S. Cl. 137/2; 137/386

(57) ABSTRACT

A toilet water supply system comprising: a used water reservoir, in addition to a tank of said toilet, for storing used water to be supplied to said toilet tank from a domestic water source; an adequate-water sensor, for sensing whether said reservoir is full; and a water-directing apparatus, for directing water from said used-water source towards said used water reservoir upon sensing that said reservoir is not full, and towards a domestic drain upon sensing that said water reservoir is full, wherein said directing is carried out using a pump and the operation thereof is regulated, wherein said water-directing apparatus, said sensor and said pump being separated from said water reservoir and the capacity of said apparatus being less than about 3 liters, thereby allowing placing said water directing apparatus in an easy accessible location, resulting with convenient maintenance.

### FIELD OF THE INVENTION

The present invention relates to the field of toilets. More particularly, the invention relates to a method and apparatus for supplying recycled water to a toilet tank.

### BACKGROUND OF THE INVENTION

Water for flushing toilets is estimated to consume about 40% of all domestic water. As such, water economy policies are directed to conserving water for toilet flushing.

The solutions in this field include water-economic toilet tanks and collection of recycled water.

The economic toilet tanks still consume fresh water. Collection of recycled water is commonly not economical.

However, despite this and other solutions introduced, toilets remain significant consumers of fresh water.

There thus remains a need to provide solutions for the above-mentioned problems.

### SUMMARY OF THE INVENTION

It is an object of the present invention to provide systems and methods for reducing the use of fresh water in toilet apparatus.

Some embodiments of the present invention are directed to systems and methods for introducing used water into toilet apparatus.

In one embodiment of the present invention, there is provided a toilet water supply system, comprising:

a) a used water reservoir, in addition to a tank of a toilet, for storing used water to be supplied to the toilet tank from a used domestic water source;

b) an adequate-water sensor for sensing whether the reservoir is full; and

c) a water-directing apparatus (WDA) for directing water from the used-domestic water source towards the used water reservoir upon sensing that the reservoir is not full, and towards a domestic drain upon sensing that the water reservoir is full, wherein the directing is carried out using a pump and the operation thereof is regulated,

wherein the water-directing apparatus, the sensor and the pump are separated from the water reservoir and the capacity of the apparatus is less than about 3 liters, thereby allowing placing the water directing apparatus in an easy accessible location, resulting with convenient maintenance.

The water-directing apparatus may comprise:

a) an inlet for receiving the used water;

b) a water pump for pumping the received water through a used water outlet to the reservoir; and

c) a waste outlet for removing excess water upon sensing that the reservoir is full.

The waste outlet may be located at the top of the WDA, and

the WDA may comprise:

i) a service compartment comprising the inlet, the used water outlet and the water pump and a waste-water compartment comprising the waste outlet,

wherein the compartments may be connected therebetween at a lower end thereof, for having equal levels of water, thereby being adapted to:

a) lower the equal levels upon activation of the water pump; and

b) raise the equal levels, for removing the water towards the waste outlet.

The WDA may further comprise a first water-level sensor, for sensing a certain level (L3) of the equal levels to activate the water pump thereabove.

The toilet water supply system may further comprise a Schmitt-trigger switch for Schmitt-activating the water pump between two levels (L2, L3) of the first level sensor.

The adequate-water sensor may comprise a pressure switch (not shown) for sensing the water pressure towards the water reservoir.

According to another embodiment, the adequate-water sensor may comprise a second level sensor for sensing the water level of the reservoir.

The first water-level sensor may comprise a float or electrode sensors.

The second water-level sensor may comprise a float or an electrode sensor.

In another aspect the present invention is directed to a method for supplying water to a toilet, the method comprising the steps of:

a) receiving used water from a domestic water facility into a water-directing apparatus;

b) upon sensing by a sensor that a used water reservoir is not full, pumping the received water to the water reservoir;

c) upon sensing by the sensor that the reservoir is full, directing excess water into a domestic drain, and de-activating the pumping; and

d) supplying the water of the reservoir to a toilet tank;

wherein the water-directing apparatus, the sensor and the pump being separated from the water reservoir and the capacity thereof being less than about 3 liters, thereby allowing placing the water directing apparatus in an easy accessible location, resulting with convenient maintenance.

The step of pumping may further require the step of sensing an adequate level (L3) of the received water.

The step of sensing that the reservoir is full may comprise sensing pressure of the pumped water.

According to another embodiment, the step of sensing that the reservoir is full may comprise sensing the level of water at the reservoir.

The foregoing embodiments of the invention are described and illustrated in conjunction with systems and methods thereof, which are meant to be merely illustrative, and not limiting.

### BRIEF DESCRIPTION OF THE DRAWINGS

The invention will now be described in connection with certain embodiments with reference to the following illustrative figures so that it may be more fully understood.

With specific reference now to the figures in detail, it is stressed that the particulars shown are by way of example and for purposes of illustrative discussion of the embodiments of the present invention only and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a simplified schematic illustration showing a toilet water supply system, in accordance with an embodiment of the present invention;

FIG. 2A is a simplified schematic illustration showing a water-directing apparatus at a first step of use, in accordance with an embodiment of the present invention;

FIG. 2B is a simplified schematic illustration showing a water-directing apparatus at a second step of use, in accordance with an embodiment of the present invention;

FIG. 3 is a simplified schematic illustration showing a water-directing apparatus at a third step of use, in accordance with an embodiment of the present invention;

FIG. 4 is a simplified schematic illustration showing a water-directing apparatus at a fourth step of use, in accordance with an embodiment of the present invention;

FIG. 5 is a simplified schematic illustration showing a water-directing apparatus at a fifth step of use, in accordance with an embodiment of the present invention;

FIG. 6 is a simplified schematic illustration of the water and electric components of the water-directing apparatus of FIG. 1, in accordance with an embodiment of the present invention;

FIG. 7 is a simplified schematic illustration of one system using the water-directing apparatus of FIG. 1, in accordance with an embodiment of the present invention;

FIG. 8 is a simplified schematic illustration depicting the reservoir of FIG. 7, in accordance with an embodiment of the present invention; and

FIG. 9 is a simplified schematic illustration depicting another reservoir of FIG. 7, in accordance with an embodiment of the present invention;

It should be understood that the drawings are not necessarily drawn to scale.

### DETAILED DESCRIPTION OF THE INVENTION

The present invention will be understood from the following detailed description of embodiments, which are meant to be descriptive and not limiting. For the sake of brevity, some well-known features, methods, systems, procedures, components, circuits, and so on, are not described in detail.

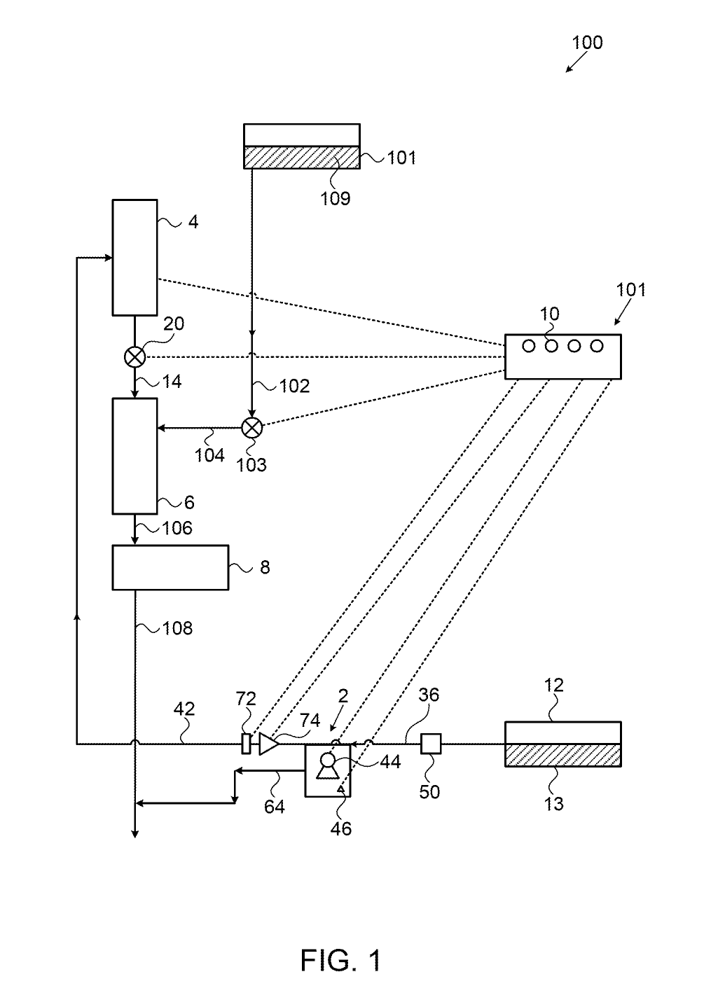

Reference is now made to FIG. 1, which is a simplified schematic illustration showing a toilet water supply system 100, in accordance with an embodiment of the present invention.

System 100 comprises a clean water tank 101, a used water reservoir 4 which both feed into a toilet tank 6. The general idea of the system is to use used water 13 from the used water reservoir 4 and only use clean water 109 from the clean water tank when there is no/little water in the used water reservoir.

An electric control unit 101 comprising at least one visual indicator, comprises communication functions 107 (not shown) for sending and receiving electronic signals to and from reservoir 4, at least one faucet 20, a water level sensor 46; a tap 103; an adequate-water sensor 72, a one way valve 74 and optionally to other parts of system 100.

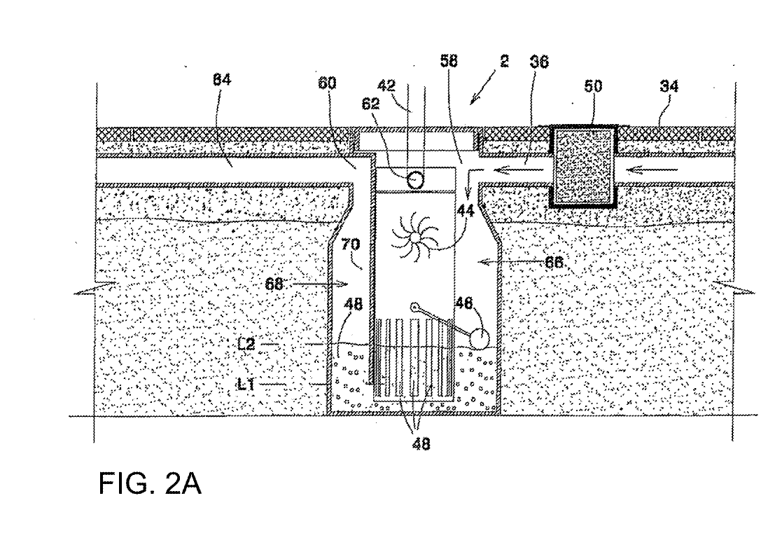

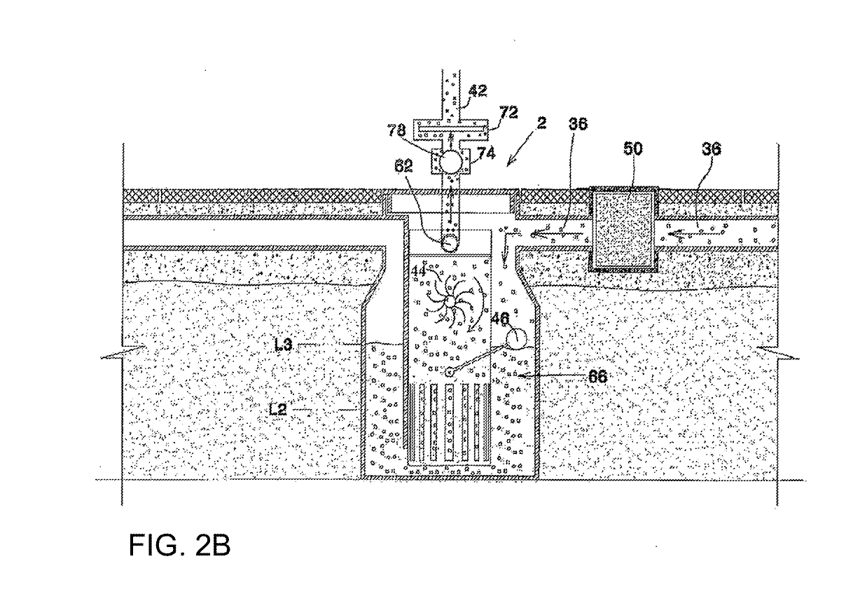

Electric control unit 101 is constructed and configured to maximize the safe transfer of used water from at least one used water source 12 via system 100 to toilet tank 6. The steps of the method in which this is performed are described in further detail with respect to FIGS. 2A-5 hereinbelow.

Used water 13 is transferred from used water source(s) 12 via a filter 50 to water directing apparatus 2. The operation of water directing apparatus 2 is described further hereinbelow. When sufficient used water accumulates in water directing apparatus 2, it is passed to reservoir 4 and then used to fill toilet tank 6.

When there is too much used water in water directing apparatus 2, some/all of it is passed via waste water pipe 64 to a sewage line 108.

One advantage of system 100 is that it is constructed and configured to save at least one percent of the clean water domestic supply usage of a domestic dwelling.

According to further embodiments of the present invention, system 100 is constructed and configured to save at least five percent of the clean water domestic supply usage of a domestic dwelling.

According to further embodiments of the present invention, system 100 is constructed and configured to save at least ten percent of the clean water domestic supply of a domestic dwelling.

According to further embodiments of the present invention, system 100 is constructed and configured to save at least twenty percent of the clean water domestic supply usage of a domestic dwelling.

According to further embodiments of the present invention, system it is constructed and configured to save at least twenty percent of the clean water domestic supply usage of a domestic dwelling.

According to further embodiments of the present invention, system 100 is constructed and configured to save between 0.1 to 20% the clean water supply usage of a commercial establishment.

Another advantage of system 100, is that it is constructed and configured to reduce between 0.1 to 40% of used waste water of a domestic dwelling.

Another advantage of system 100, is that it is constructed and configured to reduce between 0.1 to 40% of used waste water of a commercial establishment.

FIG. 2A depicts a water-directing apparatus, according to one embodiment of the present invention, at the first step of use.

A water-directing apparatus (WDA) 2 includes an inlet 58 from an inlet pipe 36 of used water; a waste water outlet 60 removing excess water to a waste-water pipe 64; and a used water outlet 62, which is the outlet of a water pump 44, raising water to a used water pipe 42.

Water-directing apparatus (WDA) 2 includes a service compartment 66 and a waste-water compartment 68, partitioned by a partition 70. However, partition 70 does not partition between compartments 68 and 70 below a low level L1; thus, according to the connected vessels law, the level of the water is equal in both compartments.

At the first step, depicted in FIG. 1, the water level is L2, which is above level L1.

Water pump 44 in service compartment 66 is controlled by a water level sensor, such as by float 46, in that compartment. Float 46 turns water pump 44 to off upon reaching level L2 and below.

Water pump 44 includes holes 48 around level L2; thus, when water pump 44 is off, according to the connected vessels law, the level of the water in water pump 44 is also L2.

Thus at step 1, no water exits WDA 2, neither through waste water outlet 60 nor through used water outlet 62.

FIG. 2 depicts the water-directing apparatus of FIG. 1 at the second step.

At the second step, used water enters inlet pipe 36, flows through inlet 58 into service compartment 66. Upon exceeding level L3 at compartment 66 (and 68), float 46 activates water pump 44, pressing water through used water outlet 62 towards used water pipe 42.

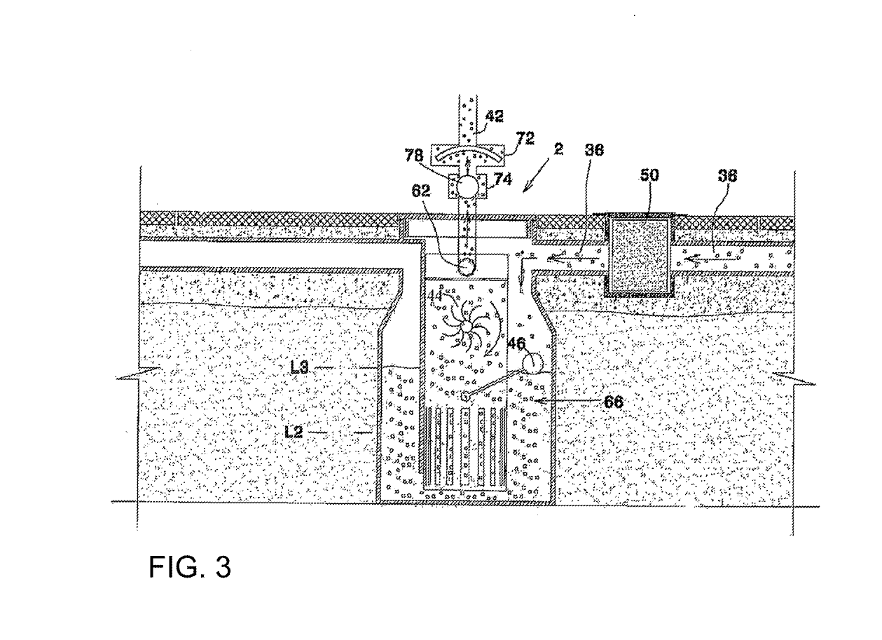

FIG. 3 depicts the water-directing apparatus of FIG. 1 at the third step.

A pressure switch (“pressostat”) is a switch that makes or cuts off electrical contact when a certain set pressure has been reached on its input.

At the third step, the water pumped by water pump 44 presses, upon presence of a block on used water pipe 42, a pressure switch 72. Bending of pressure switch 72 turns water pump 44 off.

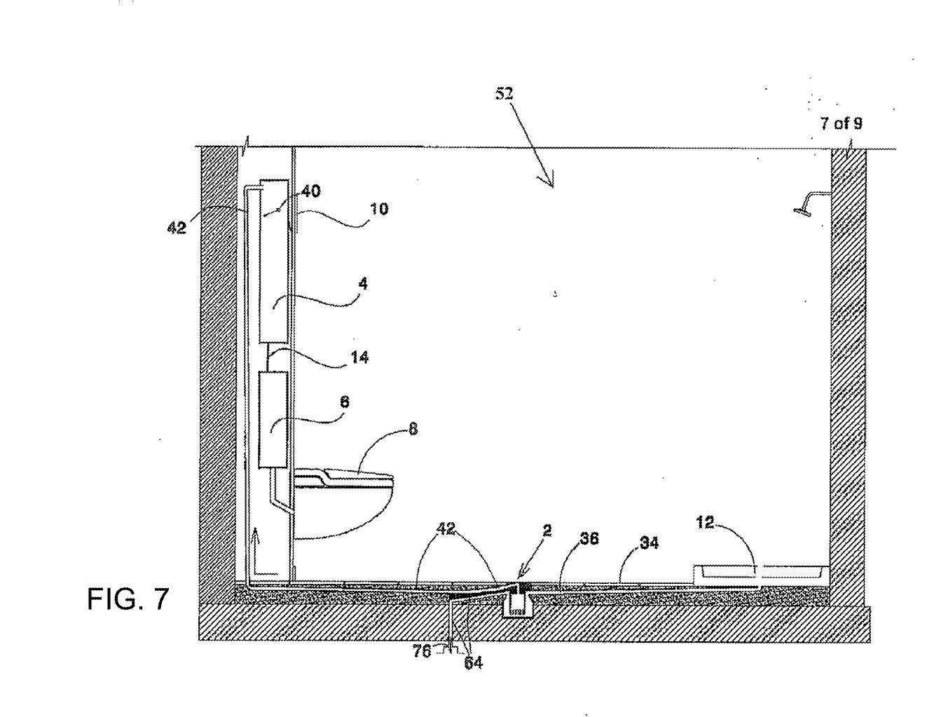

According to another embodiment, turning off water pump 44 may be triggered by a float 40 at another site (depicted in FIG. 7), instead of pressure switch 72, upon being raised by water from used water pipe 42.

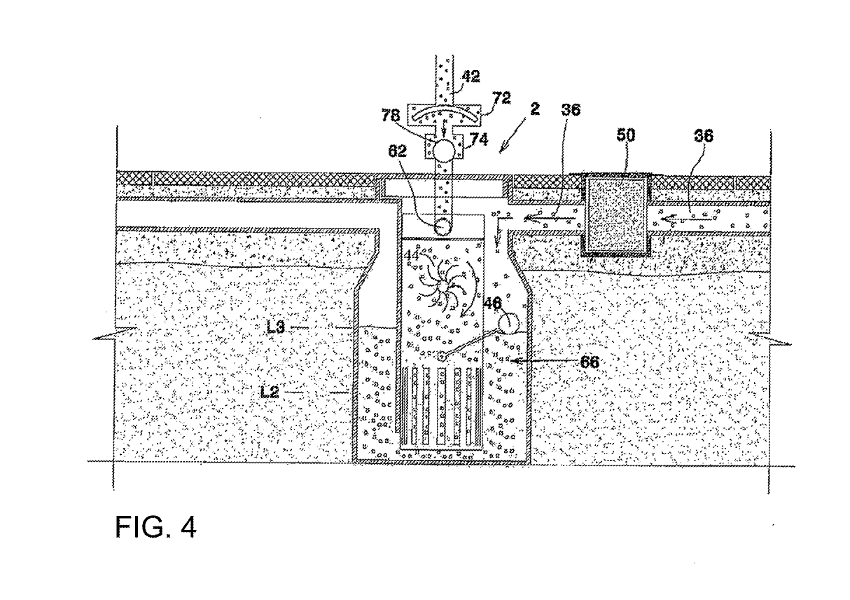

FIG. 4 depicts the water-directing apparatus of FIG. 1 at the fourth step.

A one-way valve 74 may support the pressure switch 72 embodiment.

One-way valve 74 having a ball 78 which water pump 44 opened at step 2, may close passage at step 4 by the produced pressure. One-way valve 74 may retain the off state of pressure switch 72 as long as pipe 42 is pressured, avoiding turning water pump 44 on and off alternately.

One-way valve 74 allows pressure switch 72 to stably turn off water pump 44. Thus, at step 4 water pump 44 does not pump water out, and the water in water pump 44 sinks back to the level in compartments 66 and 68.

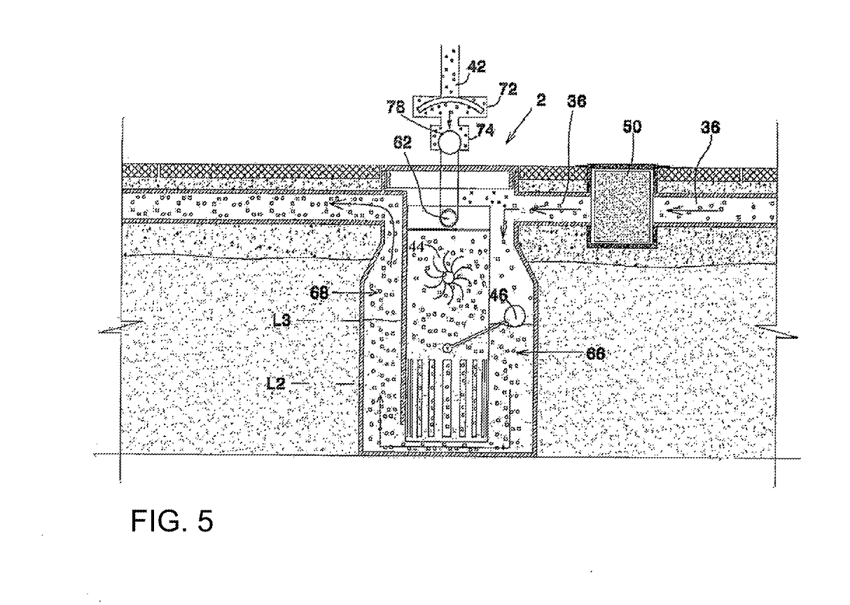

FIG. 5 depicts the water-directing apparatus of FIG. 1 at the fifth step.

At the fifth step, used water continues entering service compartment 66. The water level rises both in service compartment 66 and waste-water compartment 68. Upon exceeding the level of waste-water pipe 64, the water drains therethrough.

Thus, at step 5 non-pressured water drains naturally by the connected vessels law, from inlet pipe 36 into waste-water pipe 64.

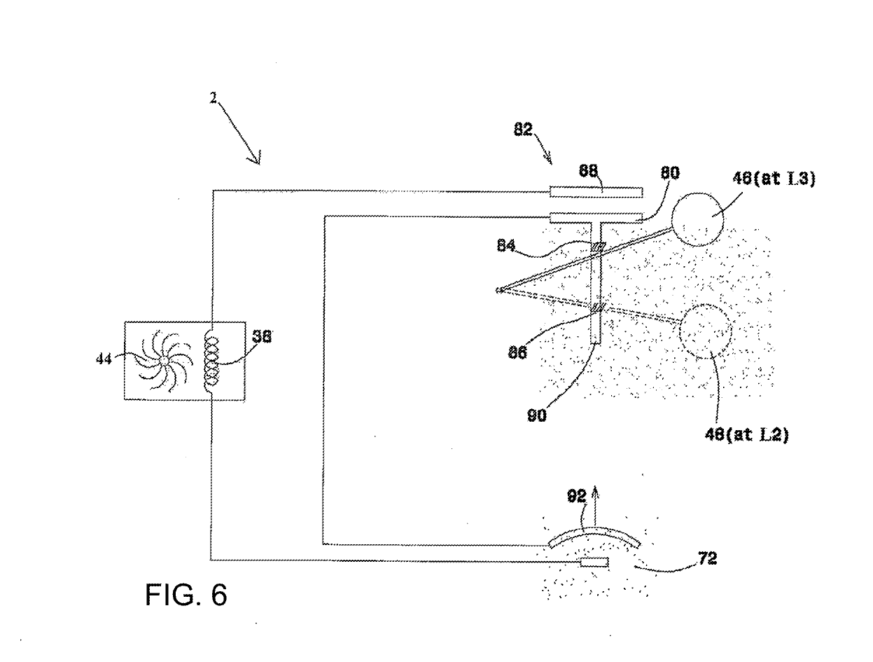

FIG. 6 is a schematic illustration of the water and electric components of the water-directing apparatus of FIG. 1.

Float 46 connects a water level switch 82 upon being raised up to level L3, and disconnects water-level switch 82 upon being lowered to level L2.

The term “Schmitt trigger switch” refers herein to a switch which is connected when the input reaches a certain high threshold; and disconnected when the input reaches a certain low threshold; when the input is between the two, the switch retains its last state.

The term “Schmitt activating” refers herein to activation according to a Schmitt trigger switch.

Preferably, water-level switch 82 is a Schmitt-trigger switch, meaning that switch 82 retains its last state between levels L2 and L3.

According to one embodiment, Schmitt-trigger switch 82 includes a stationary contact 88 and a movable contact 80, which is movable by an arm 90. Arm 90 includes a high protrusion 84 and a low protrusion 86. Upon raising float 46 to level L3, float 46 raises high protrusion 84, connecting movable contact 80 to stationary contact 88. Upon lowering float 46 to level L2, float 46 lowers low protrusion 86, disconnecting movable contact 80 from stationary contact 88.

According to one embodiment, pressure switch 72 includes a contact 92 connected to a membrane which disconnects contact 92 from the stationary contact upon water pressure above a certain threshold.

The electric load 38 of water pump 44 is activated only if both water-level switch 82 and pressure switch 72 are connected, meaning that the water level is above the Schmitt trigger level and that the water pressure is below a threshold.

FIG. 7 is an application using the water-directing apparatus of FIG. 1.

Drain water from a shower or any other drain-water source 12 flows under vessel 34 into inlet pipe 36 of WDA 2. WDA 2 raises some of the water into used water pipe 42 and further into a reservoir 4. Filling reservoir 4 may be sensed by pressure switch 72 in WDA 2 or by float 40 in reservoir 4. Upon filling reservoir 4, WDA 2 stops supplying the shower water to reservoir 4 and drains it to drain 76 through waste-water pipe 64.

Since the quantity of bath water commonly consistently exceeds the quantity of toilet water, reservoir 4 may supply the water to toilet tank 6 for toilet 8 through pipe 14 eliminating network water supply.

According to another embodiment, reservoir 4 and toilet tank 6 are a single tank. Reservoir 4 may include a visual indicator 10 of the water level. Upon indicating high water level, the user is recommended to use the full tank flush selection.

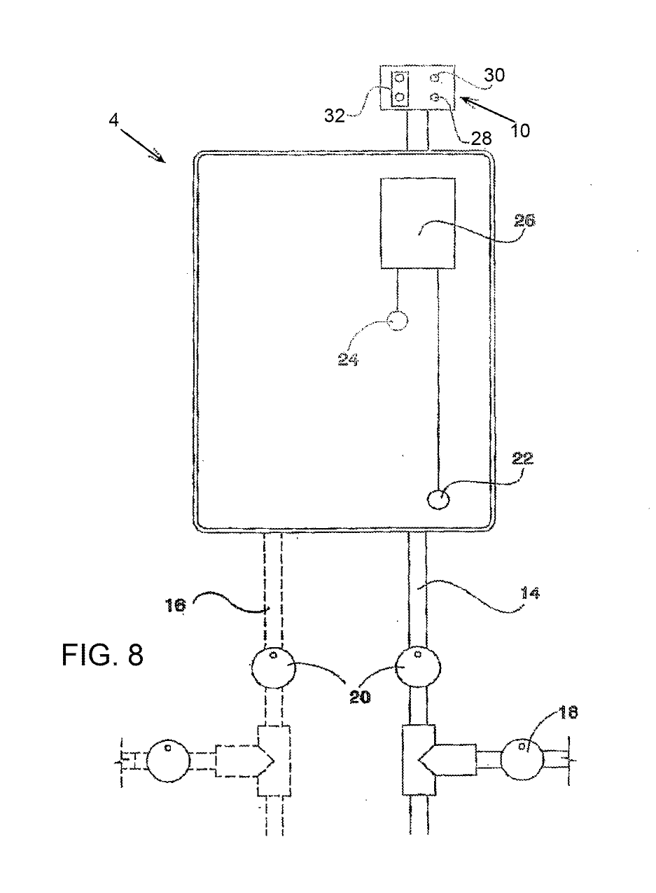

FIG. 8 depicts the reservoir of FIG. 7 in detail and according to further embodiments.

Float 40 in reservoir 4 may be replaced by a high water-level sensor electrode 24 and low water-level sensor electrode 22, both providing signals to an electronic circuit 26.

Visual indicator 10 may include an empty tank indicator 28 and a full tank indicator 30 and additional indicators 32.

Reservoir 4 may supply water to other consuming devices, such as depicted by pipe 14 supplying to toilet tank 6 and pipe 16 supplying another consuming device. Each consuming device receives water from reservoir 4 through a faucet 20 and/or through the network water from a faucet 18.

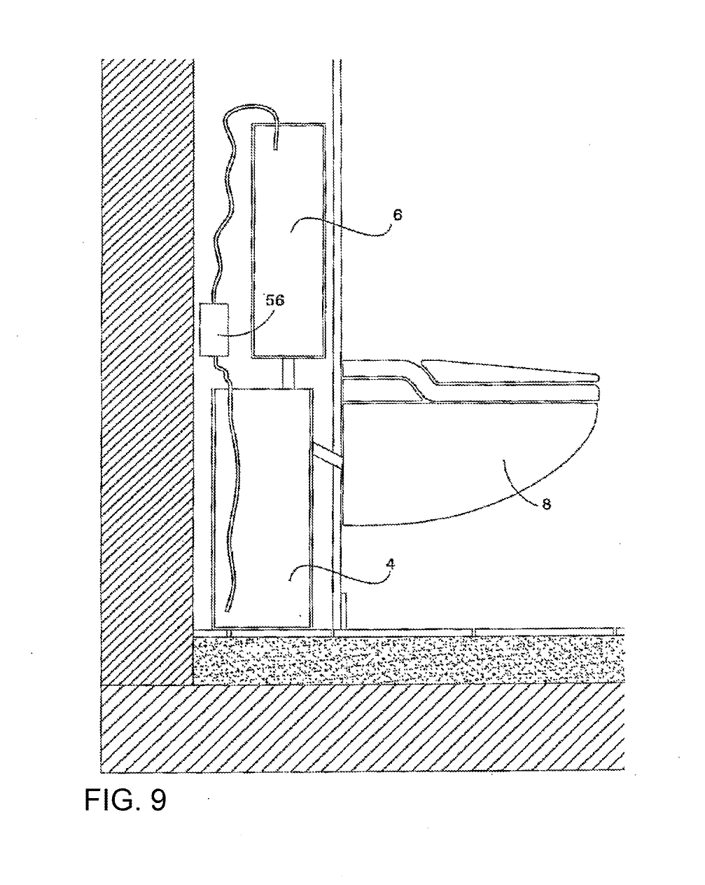

FIG. 9 depicts the reservoir of FIG. 7, according to another embodiment.

FIG. 9 is similar to FIG. 7, except that reservoir 4 may be located anywhere, including below toilet tank 6. An additional water pump 56 pumps water from reservoir 4 to toilet tank 6. Water pump 56 may be activated upon removal of water from toilet tank 6, or at any time when toilet tank 6 is not full.

Actually, the water directing apparatus 2 is a flow control box that controls the used water passage from domestic source(s) like shower 12, to the water reservoir 4.

In order to allow convenient access to the control box, according to a embodiment of the invention the following adaptations are made: (a) the capacity of the water directing apparatus is set to less than about 3 liters, and (b) all the control facilities are disposed in the control box. The result is a “small” control box 2, which therefore can be installed in a convenient location.

Technically, some control operations, such as controlling the water level in the reservoir, can be made by placing a float inside the reservoir. However, as the capacity of common flush toilets is between 6 to 17 liters, and since the size of the reservoir should allow a plurality of flushing actions, its size is “big”, which does not allow much freedom in placing the reservoir in a convenient location (actually, the location dictated by the building). However, a control box having a capacity of about 3 liters as in the present invention is “small” enough to allow its placing in a more convenient location.

In the figures and/or description herein, the following reference numerals have been mentioned:
numeral 2 denotes a water directing apparatus (WDA) according to one embodiment of the present invention;
numeral 4 denotes a reservoir;
numeral 6 denotes a toilet tank;
numeral 8 denotes a toilet;
numeral 10 denotes a visual indicator of the water level in the reservoir;
numeral 12 denotes a shower or any other water source supplying water for collecting for recycling;
numerals 14 16, 102, 104, 106, 108 denote water pipes;
numerals 18, 20, and 103 denote faucets;
numeral 22 denotes a low water-level sensor;
numeral 24 denotes a high water-level sensor;
numeral 26 denotes an electronic circuit;
numeral 28 denotes an empty tank indicator;
numeral 30 denotes a full tank indicator;
numeral 32 denotes an additional indicator, e.g. temperature;
numeral 34 denotes a vessel directing the shower's water to the drain;
numeral 36 denotes the inlet pipe of the WDA;
numeral 38 denotes the electric load of the water pump;
numeral 40 denotes a float or other level sensor at the reservoir;
numeral 42 denotes the used water pipe of the WDA;
numeral 44 denotes a water pump;
numeral 46 denotes a water level sensor, which may be a float, for sensing the water level in the WDA;
numeral 48 denotes a hole for water entering the water pump;
numeral 50 denotes a water filter;
numeral 52 denotes a toilet water supply system, according to one embodiment of the present invention;
numeral 56 denotes an additional water pump for an embodiment in which the reservoir is located below the toilet tank;
numeral 58 denotes the inlet of the WDA;
numeral 60 denotes the waste outlet of the WDA;
numeral 62 denotes the used water outlet of the WDA;
numeral 64 denotes the waste-water pipe;
numeral 66 denotes a service compartment, which is the compartment of the WDA including the inlet and the used water outlet;
numeral 68 denotes a waste-water compartment;
numeral 70 denotes a partition between the compartments of the WDA;
numeral 71 denotes a pressure switch;
numeral 72 denotes an adequate-water sensor;
numeral 74 denotes a one-way valve;
numeral 76 denotes the drain;
numeral 78 denotes a ball of a one-way valve;
numeral 80 denotes a movable contact of a switch;
numeral 82 denotes a water level switch in the WDA.; according to one embodiment this switch is a Schmitt-trigger switch;
numerals 84 and 86 denote protrusions on the arm of the Schmitt-trigger switch;
numeral 88 denotes a stationary contact of the Schmitt-trigger switch;
numeral 90 denotes an arm of the Schmitt-trigger switch; and
numeral 92 denotes a contact of the pressure switch.

The foregoing description and illustrations of the embodiments of the invention has been presented for the purposes of illustration. It is not intended to be exhaustive or to limit the invention to the above description in any form.

Any term of the claims that has been defined above, has to be interpreted according to this definition.

It is to be understood that the invention is not limited in its application to the details set forth in the description contained herein or illustrated in the drawings. The invention is capable of other embodiments and of being practiced and carried out in various ways. Those skilled in the art will readily appreciate that various modifications and changes can be applied to the embodiments of the invention as hereinbefore described without departing from its scope, defined in and by the appended claims.

What is claimed is:

1. A toilet water supply system, comprising:
a) a used water reservoir, in addition to a tank of said toilet, for storing used water to be supplied to said toilet tank from a domestic water source;
b) an adequate-water sensor, for sensing whether said reservoir is full; and
c) a water-directing apparatus, for directing water from said used-water source towards said used water reservoir upon sensing that said reservoir is not full, and towards a domestic drain upon sensing that said water reservoir is full, wherein said directing is carried out using a pump and the operation thereof is regulated,
wherein said water-directing apparatus, said sensor and said pump being separated from said water reservoir and the capacity of said apparatus being less than about 3 liters, thereby allowing placing said water directing apparatus in an easy accessible location, resulting in convenient maintenance.

2. A toilet water supply system according to claim 1, wherein said water-directing apparatus comprises:
i. an inlet, for receiving said used water;
ii. a used water outlet, for pumping said received water by said pump therethrough to said reservoir; and
iii. a waste outlet, for removing excess water upon said sensing that said reservoir is full.

3. A toilet water supply system according to claim 2,
wherein said waste outlet is located at the top of said water-directing apparatus, and
wherein said water-directing apparatus further comprises:
a) a service compartment comprising said inlet, said used water outlet and said water pump; and
b) a waste-water compartment comprising said waste outlet,
wherein said compartments are connected therebetween at a lower end thereof, for having equal levels of water,
thereby being constructed to:
i. lower said equal levels upon activation of said water pump, and
ii. raise said equal levels, for removing said water towards said waste outlet.

4. A toilet water supply system according to claim 3, wherein said water-directing apparatus further comprises a first water-level sensor, for sensing a certain level of said equal levels to activate said water pump thereabove.

5. A toilet water supply system according to claim 4, further comprising a Schmitt-trigger switch, for Schmitt-activating said water pump between two levels of said first level sensor.

6. A toilet water supply system according to claim 1, wherein said adequate-water sensor comprises a pressure switch sensing the water pressure towards said water reservoir.

7. A toilet water supply system according to claim 1, wherein said adequate-water sensor comprises a second level sensor sensing the water level of said reservoir.

8. A toilet water supply system according to claim 4, wherein said first water-level sensor comprises a member selected from a group including: a float, an electrode sensor.

9. A toilet water supply system according to claim 7, wherein said second water-level sensor comprises a member selected from a group including: a float, an electrode sensor.

10. A method for supplying water to a toilet, said method comprising the steps of:
a) receiving used water from a domestic water facility into a water-directing apparatus;
b) upon sensing by a sensor that a used water reservoir is not full, pumping the received water to said water reservoir;
c) upon sensing by said sensor that said reservoir is full, directing excess water into a domestic drain, and de-activating said pumping; and
d) supplying the water of said reservoir to a toilet tank;
wherein said water-directing apparatus, said sensor and said pump being separated from said water reservoir and the capacity thereof being less than about 3 liters, thereby allowing placing said water directing apparatus in an easy accessible location, resulting with convenient maintenance.

11. A method according to claim 10, wherein said step of pumping further requires the step of sensing an adequate level of said received water.

12. A method according to claim 10, wherein said step of sensing that said reservoir is full comprises sensing pressure of said pumped water.

13. A method according to claim 10, wherein said step of sensing that said reservoir is full comprises sensing the level of water at said reservoir.

14. A water-directing apparatus, for directing water from a used-water source towards a used water reservoir upon sensing that a reservoir is not full, and towards a domestic drain upon sensing that said water reservoir is full, wherein said directing is carried out using a pump and the operation thereof is regulated, and wherein said water-directing apparatus, a sensor and said pump are separated from said water reservoir.

15. A water-directing apparatus according to claim 14, wherein said apparatus has a capacity of less than about 3 liters.

16. A water-directing apparatus according to claim 15, wherein said apparatus is constructed to enabling placing thereof in an easy accessible location for convenient maintenance.

17. A water-directing apparatus according to claim 14, wherein said apparatus is controlled by at least one electronic sensor.

18. A water-directing apparatus according to claim 14, wherein said apparatus is controlled by at least one electronic sensor.

19. A water-directing apparatus according to claim 14, wherein said at least one electronic sensor is part of a remote electronic control unit.

20. A water-directing apparatus according to claim 14, wherein said electronic control unit further controls sensors in a used domestic water reservoir.
